(19) United States
(12) Patent Application Publication
(10) Pub. No.: US 2007/0075545 A1
(43) Pub. Date: Apr. 5, 2007

(54) Zero pollution vertical/linear electrical generation facility

(76) Inventors: Eddie K. Wilson SR., Memphis, TN (US); Linda D. Studdard, Ocean Springs, MS (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/542,071

(22) Filed: Oct. 3, 2006

Related U.S. Application Data
(60) Provisional application No. 60/723,753, filed on Oct. 5, 2005.
(60) Provisional application No. 60/776,180, filed on Feb. 23, 2006.

(51) Int. Cl. H02K 7/18; F03G 7/08; F02B 63/04

(52) U.S. Cl. 290/1 R

(57) ABSTRACT

An electrical generation facility includes a drive unit and an electrical generation unit. The drive unit takes the form of a pump jack of the type commonly used to extract oil from oil fields. As such it has a walking beam to which a rocking motion is imparted by a motor. At its one end the beam has a head provided with a convex surface. The generation unit includes a stator provided with coils and an armature having magnets. The armature is coupled to the beam through a rod and a cable, the latter of which that passes over the convex surface of the head at the end of the beam. Thus, when the beam pivots back and forth the armature moves along the coils of the stator. The magnetic flux induces a current in the coils. The coils may be arranged in sets and a separate armature way exist for each set.

### CROSS-REFERENCE TO RELATED APPLICATIONS

This application derives and claims priority from U.S. provisional application 60/723,753, filed Oct. 5, 2005, and U.S. provisional application 60/776,180, filed Feb. 23, 2006, both of which are incorporated herein by reference.

### STATEMENT REGARDING FEDERALLY SPONSORED RESEARCH

Not Applicable.

### BACKGROUND OF THE INVENTION

This invention relates in general to the production of electrical energy and more particularly to a facility and process for generating electrical energy.

Much of the electrical energy used by the United States and other countries, as well, derives from fossil fuels such as coal, oil and natural gas. But as the finite reserves of these fuels are consumed, the fuels become more difficult and expensive to extract, thus increasing the cost of producing electrical energy. Moreover, their use introduces carbon dioxide and, in the case of some fuels, significant pollutants into the atmosphere, creating harmful conditions such as smog and perhaps global warming. Other sources of electrical energy have their detractions as well. For example, hydroelectric projects usually include dams, which require huge capital expenditures and inundate land that could otherwise be put to productive purposes. Nuclear power plants are also costly and produce radioactive wastes which must be disposed of safely. Wind-powered generators are unreliable, because they depend on winds that can vary in direction and magnitude, and furthermore they do not produce much power. Solar units are likewise deficient, because they require sun, which in many parts of the world shines infrequently, and furthermore such units produce only minimal power.

Apart from that, much of the equipment for producing electrical energy relies on pure rotary motion, both at the prime mover and at the electrical generator. Typically, the prime mover takes the form of a turbine that extracts energy from steam, wind, radioactive materials, hot gases, or falling water. To be sure, internal combustion engines with reciprocating pistons power some electrical generators, but even this type of prime mover delivers power through a rotating crank shaft.

Some prime movers deliver power through reciprocating mechanisms, often in to-and-fro movement. But few electrical generators can accommodate this motion. Instead, the to-and-fro movement must be converted into a rotary motion, and that adds to the complexities of the machine and makes it more difficult to maintain.

The depletion of oil reserves has left many oil fields with unused pumping equipment. It simply remains idle, having no other useful purpose.

### BRIEF DESCRIPTION OF THE SEVERAL VIEWS OF THE DRAWINGS

FIG. 1 is a side elevational view, partially in section, of an electrical generating facility constructed in accordance with and embodying the present invention;

FIG. 2 is an enlarged sectional view of the generating unit forming part of the electrical facility;

FIG. 3 is a sectional view of a modified generating unit for the facility;

FIG. 4 is a schematic perspective view of another modified generating unit;

FIG. 5 is a perspective view of the armature for still another modified generating unit that produces three phase current;

FIG. 6 is a side elevational view of a drive unit for a modified electrical generating facility;

FIG. 7 is a end elevational view of the drive unit for modified electrical generating facility of FIG. 6;

FIG. 8 is an enlarged view of the vertical linear generator for the facility; and

FIG. 9 is a sectional view of the vertical/linear generator taken along line 9-9 at FIG. 8.

### DESCRIPTION OF THE PREFERRED EMBODIMENT

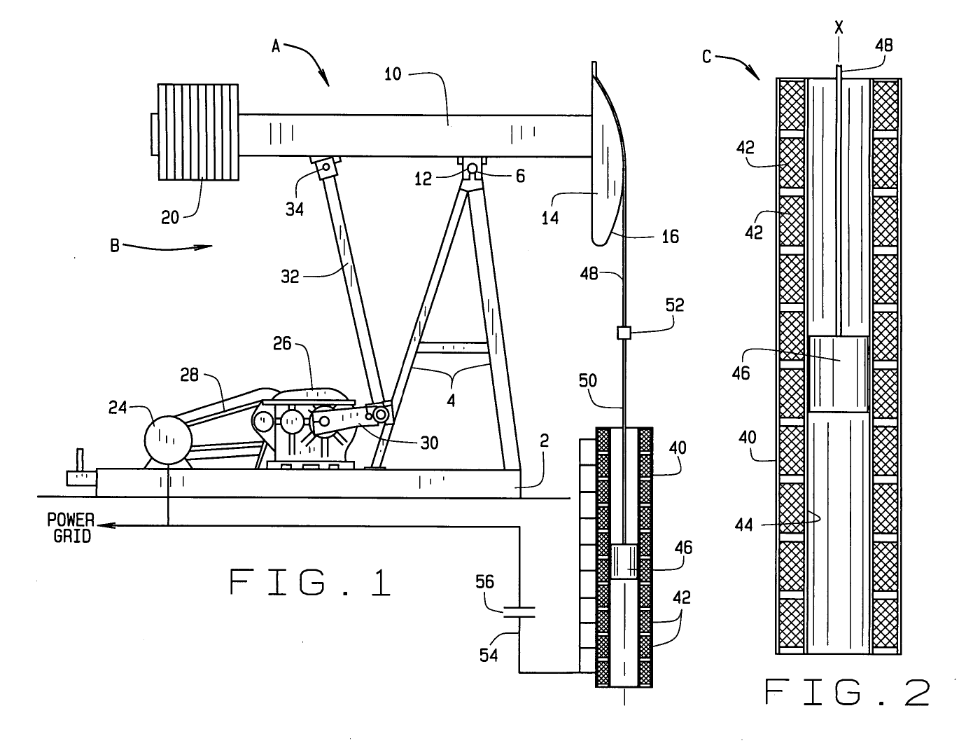

Referring now to the drawings an electrical generation facility A (FIGS. 1 & 2) produces sufficient electrical energy for delivery to a grid so that the electricity may be consumed elsewhere. The facility A includes a drive unit B and a generating unit C. The former drives the latter, while the latter produces the actual electrical energy. The amount of electricity generated can be increased with the use of multiple armatures.

The drive unit B (pump jack) is powered by an electric motor to enable it to operate generating unit C (vertical generator).

This process generates a sufficient supply of electricity that is delivered to the substation to be delivered to the grid for industrial, commercial, and residential use. The amount of electricity required to operate the electric motor for drive unit B can be pulled off at the substation before it goes to the grid. This makes the process extremely cost effective, environmentally friendly, and helps fulfill the world's emergency need for clean energy.

The drive unit B is in essence a pumping unit of the type used to extract oil from oil wells, but instead of imparting a reciprocating motion to a pump rod, it imparts a reciprocating motion to a component of the generating unit C. Any of several varieties of pumping units—or so-called “pump jacks”—will suffice, the Churchill brand beam balanced pumping unit being one example. As such, the drive unit B of facility A includes a frame 2 that rests on a foundation and includes a post 4 that projects upwardly. At its upper end the post 4 is fitted with bearings 6 that are located along a transverse axis.

The post 4 supports a walking beam 10 having between its ends trunnions 12 that project laterally and are received in the bearings 6. The arrangement is such that the beam 10 can pivot in an oscillatory manner about the common axis of the bearings 6 and the trunnions 12. At one end, the walking beam 10 is fitted with a head 14, often referred to as a “horsehead”, provided with an arcuate surface 16 that is convex and presented away from the trunnions 12. At its opposite end, the walking beam 10 carries counterweights 20.

The frame 2 of the drive unit B supports an electric motor 24 and nearby a gear reducer 26, with the two being connected by endless belts 28, or some other connecting devices, such that the gear reducer 26 is powered at a reduced velocity. The gear reducer 26 drives a crank arm 30 that rotates on it. Extending between the end of the crank arm 30 and the walking beam 10 is a connecting rod 32, it being coupled to the walking beam 10 at a bearing 34 that lies between the trunnions 12 and the counterweights 20.

When the motor 24 is energized, it rotates the crank arm 30 at a significantly slower velocity, but with a corresponding increase in torque. After all, the crank arm 30 is connected to the motor 24 through the gear reducer 26 and belts 28 or other devices. The rotating crank arm 30, being connected to the walking beam 10 through the connecting rod 32, imparts an oscillatory motion to the walking beam 10, with that motion being about the common axis of the bearings 6 and trunnions 12. The head 14 moves upwardly and downwardly and so does the counterweight 20, so that when the head 14 is elevated, the counterweight 20 is lowered and vice versa.

The generating unit C is an electrical generator and includes a stator 38 that is oriented vertically beneath the head 14 of the walking beam 10, with its length slightly exceeding the vertical displacement of the head 14 as the beam 10 oscillates. The stator 38 has a housing 40 and electrical coils 42 arranged one after the other along and within the housing 40 to provide a field. Indeed, the coils 10, which are circular, lie along an axis X that aligns with the arcuate surface 16 on the head 14 of the walking beam 10. Within the coils 42 lies a guide sleeve 44 formed from a low friction material such as Teflon polymer.

The generating unit C also includes an armature 46, which is located within the sleeve 44 where it reciprocates along the axis X of the stator 38 in response to the oscillatory motion of the walking beam 10. Indeed, the armature 46 is connected to the head 14 of the walking beam 10 through a cable 48 and a rod 50. The cable 48 extends over the arcuate surface 16 of the head 14 and is attached to the head 14 at the upper end of that surface. The rod 50 is attached to the armature 46. The cable 48 and rod 50 are joined together at a dielectric coupler 52 so that the cable 48 and drive unit B are electronically isolated from the armature 46. When the head 14 is elevated, the cable 48 extends over most of the arcuate surface 16. However, when the head 14 is lowered, the cable 48 contacts only the upper region of the arcuate surface 16. The configuration and location of the arcuate surface 16 is such that the section of cable 48 that extends between the lowermost point of contact with the surface 16 and the rod 50 remains aligned with and along the axis X, this irrespective of the angular position of the walking beam 10. The weight of the armature 46 maintains the cable 48 taut irrespective of the position of the beam 10. Indeed, the armature 46 weighs enough to overcome the electrical drag imposed on the armature 46.

The armature 46 may be a permanent magnet or an electromagnet, but with either type it preferably has its poles located along the axis X. The field comprises the coils 42 in which a current is induced as the armature 46 passes the coils 42 when the armature 46 reciprocates back and forth within the housing 40. The current from the coils 42 is used to power the motor 24 through copper wires 54 and also provides electrical energy to power other devices through the electrical power grid after the current has been rectified and inverted to the appropriate 60 Hertz frequency. Additionally, a large capacitor 54 may be employed to temporarily store energy to power the motor 24 and the grid as the armature 46 comes to halt at either end of its travel before continuing in the opposite direction.

The drive unit B may be coupled with other generating units, and they need not be oriented vertically, but instead may operate along an axis X that is inclined to the vertical, perhaps at 45°, or other angles including horizontal. Moreover, modified units may produce single phase or three phase alternating current or direct current. An internal combustion engine may be substituted for the motor 24. Also, a fuel-powered motor-generator set may supply the electrical energy for the motor 24.

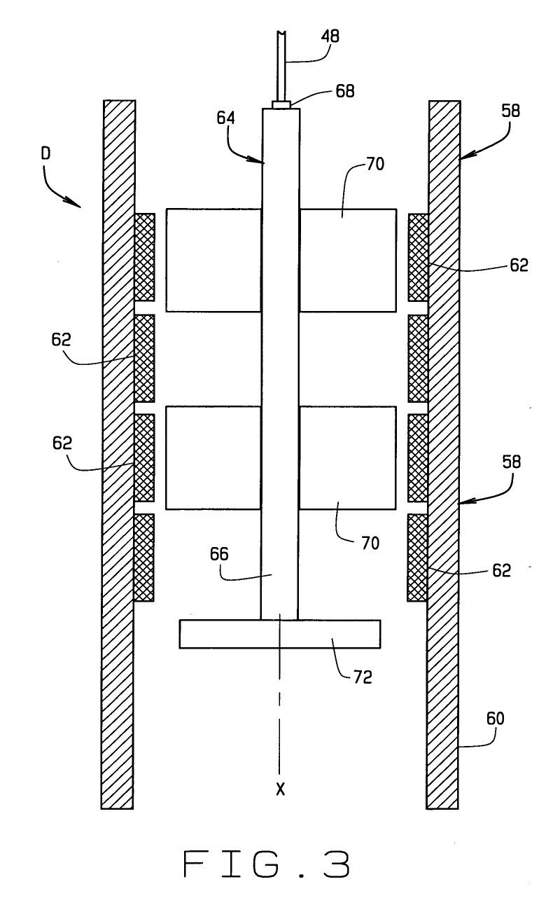

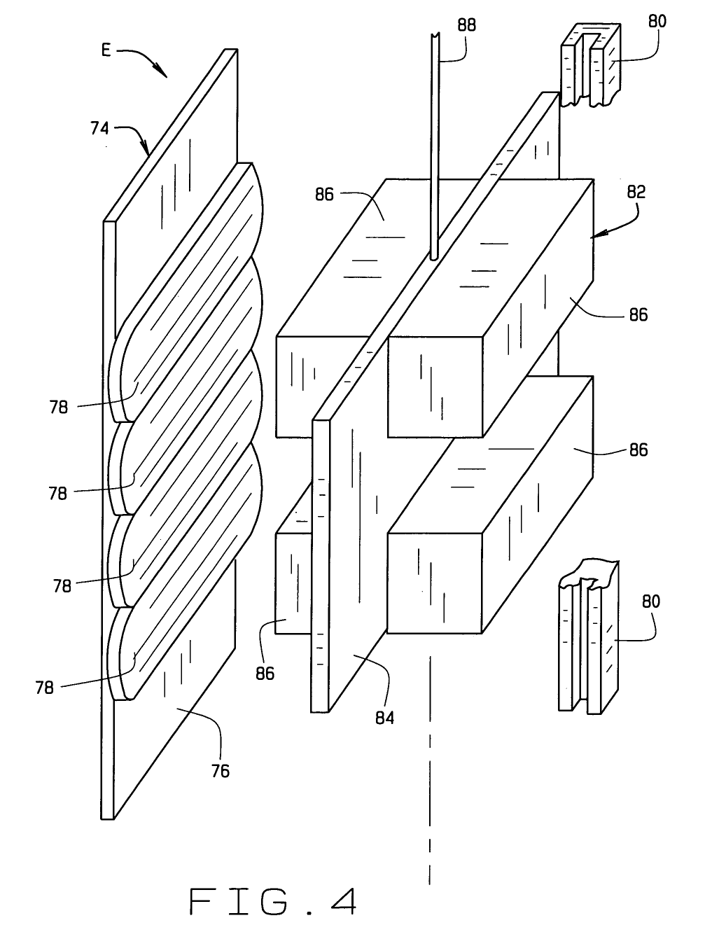

A modified generating unit D (FIG. 3) includes a stator 58 that lies along the axis X and has steel shell 60, the center of which coincides with the axis X. The shell 60 along its sides is lined with coils 62, there being a separate row of coils 62 along each side. In addition, the unit D has an armature 64 that reciprocates within the stator 58 along the axis X. The armature 64 includes a steel rod 66 that lies along the axis X and at its upper end is connected to the cable 48 through the coupler 52. The cable 48 extends over the arcuate surface 16 of the head 14 on the walking beam 10 of the drive unit B. The rod 66 carries magnets 70 that are arranged such that their poles alternate, that is to say the north pole of any magnet 70 lies next to the south poles on adjacent magnets and vice versa. At its lower end the rod 66 is fitted with a counterweight 72.

When the motor 24 of the generating unit B is energized, the walking beam 10 oscillates back and forth on its bearings 6. The armature 64, being connected to the head 14 on the walking beam 10, reciprocates in the stator 58. The magnets 70 produce a magnetic flux which passes through the field represented by the coils 62, inducing electric current in the coils 62. Small spaces should exist between the coils 62 so that the unit D produces alternating current.

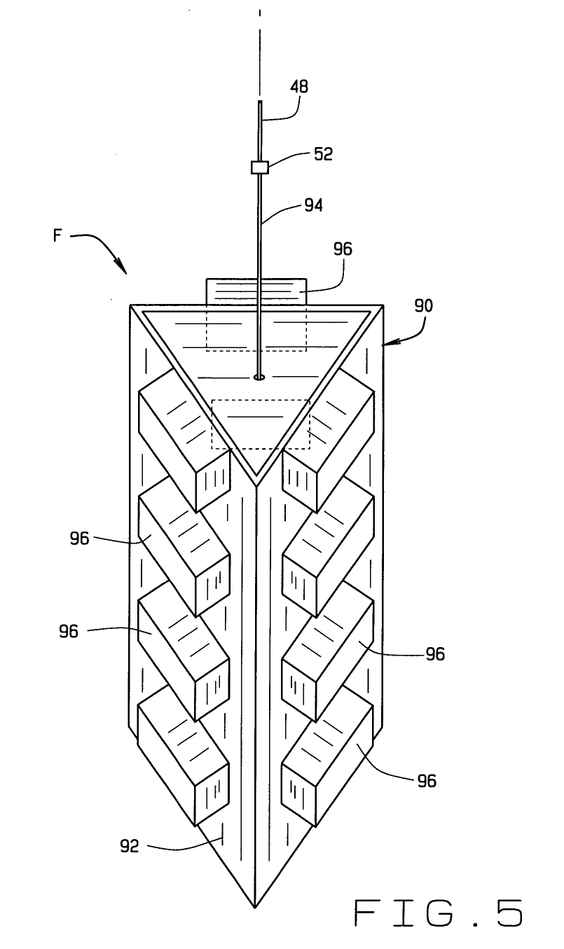

Another modified generating unit E (FIG. 4) includes a stator 74 having at least one steel plate 76 located in a fixed position and coils 78 mounted on the plate 76. The stator 74 also has grooved tracks 80 that are fixed in position with respect to the plate 76 and lie in a plane that is parallel to the plate 76.

The tracks 80 guide an armature 82 that reciprocates on them past the coils 78 that are attached to the plate 76. The armature 82 includes a center plate 84, the edges of which are received in the grooves of the tracks 80. The center plate 84 carries magnets 86 that are arranged along its face opposite the coils 78 with their north and south poles alternating. The center plate 84 is connected to a rod 88 that is in turn connected through the dielectric coupler 52 and cable 48 to the head 14 on the walking beam 10 of the generating unit B.

The magnets 86 produce a magnetic flux, and as the armature 82 moves upwardly and downwardly between the plates 76, the flux passes through the coils 78, inducing an electrical current in them.

Still another modified generating unit F (FIG. 5) produces three-phase electrical current. It includes an armature 90 having a core 92 of triangular cross section. The armature 90 is connected to the head 14 of the walking beam 10 through a rod 94 that is attached to the core 92 at the center of its upper triangular face and through the coupler 52 on the cable 48. The armature 90 also has magnets 96 mounted on the three side faces of the core 92 with their north and south poles alternating. Thus, each side face of the core 92 possesses a series of magnets 96 arranged in a row, one after the other.

As the armature 90 reciprocates the magnets 96 move past coils located on a stator, there being a separate set of coils located opposite each row of magnets 96. The magnetic flux created by the changing magnetic field induces current in each of the three sets of coils. The current is rectified and inverted into alternating currents of 60 Hertz that are out of phase by 120°.

The drive unit B may be based on other types of oil field pumping units, such as the type having a counterweight on its crank arm instead of on the beam itself or it may even be an air-balanced unit. Indeed, virtually any pumping unit can be coupled to a generating unit, such as the generating units C, D, E and F as well as variations of them, to drive such generating units. Suitable pumping units are sold by Lufkin Industries of Lufkin, Tex., George Dreher of Midland, Tex., and Weatherford International, Ltd. Crank-balanced units work as well as do air-balanced units and walking beam units. Suitable Lufkin pumping units for driving generating units are:

Conventional Crank Balanced Units (including units having 20 foot strokes)

Mark II Unitorque Units

Air Balanced Units

Reverse Mark Units

Churchill Bean Balanced Units

Low Profile Units

Portable/Trailer Mount Units

American Units

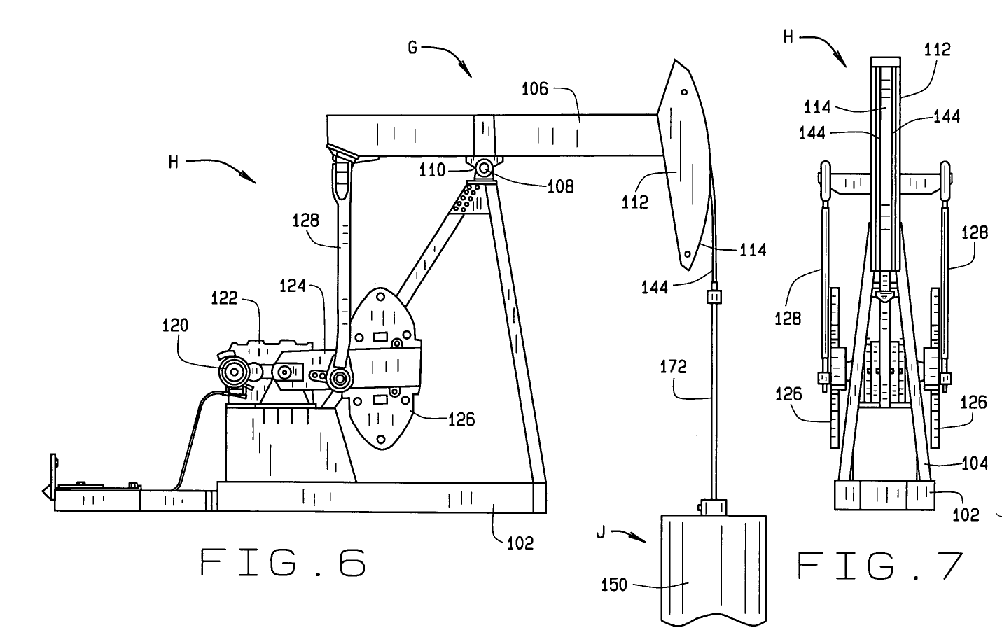

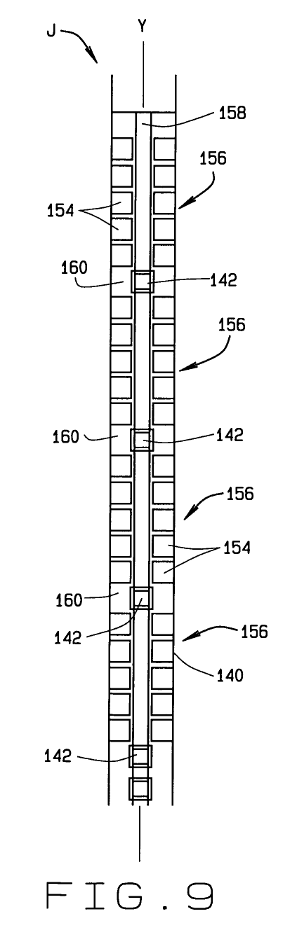

A modified electrical generating facility G (FIGS. 6-9) is in many respects similar to the facility A. It includes a drive unit H and a vertical/linear generating unit J. The latter produces enough electrical energy to power the former and supply electrical energy to a power grid as well, all without producing any air or water pollution.

The drive unit H is in essence a pumping unit—a so-called “pump jack”—of the type used in oil fields to extract oil from the earth. Any of a variety of pump jacks will suffice, provided that it has a stroke great enough to accommodate the generating unit J. In this regard, the typical pump jack imparts a reciprocating motion to a rod that extends downwardly into a drill hole, and with each upstroke the rod lifts oil from the drill hole. In the electrical generation facility G the drive unit H, that is to say the pump jack, reciprocates a component of the generating unit J.

The drive unit H, being basically a pump jack, includes (FIGS. 6 & 7) a base 102 and frame 104 that extends upwardly from the base 102. The frame 104 supports a walking beam 106 having trunnions 108 intermediate its ends, and they rotate in bearings 110 mounted on the frame 104. At one of its ends the walking beam 106 has a head 112 provided with a convex surface 114 that is presented away from the trunnions 108. The base 102 also supports an electrical motor 120 and a transmission 122. Delivering torque through the transmission 122, the motor 120 turns a crank 124 including a counterweight 126. The crank 124 is connected to the walking beam 106 through connecting rods 128. The arrangement is such that the crank 124, when rotated, imparts an oscillating motion to the walking beam 106, causing the head 112 at the end of the walking beam 106 to move upwardly and downwardly.

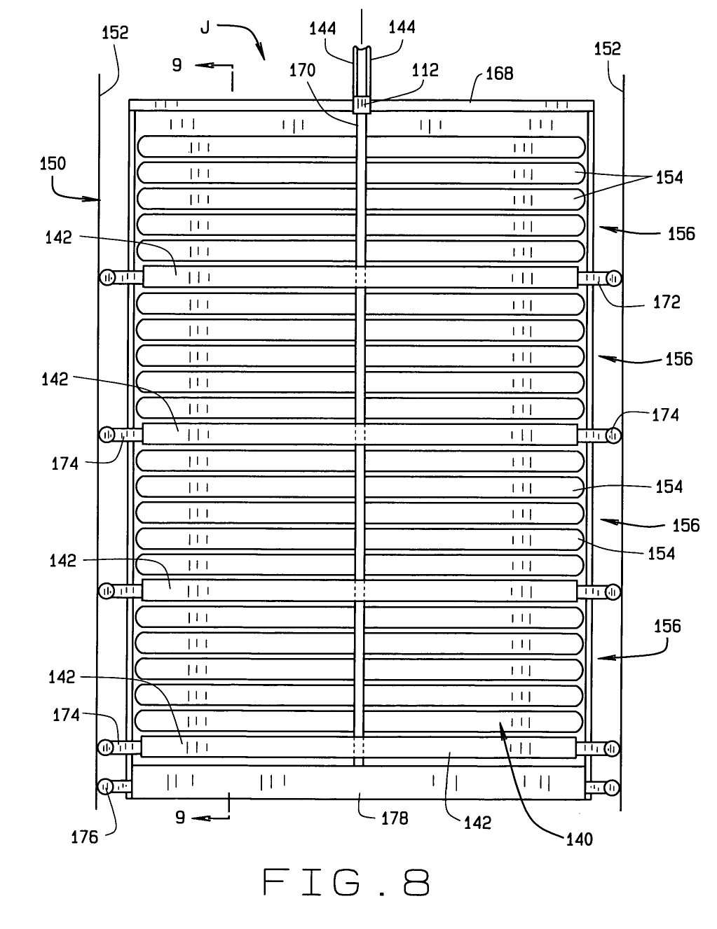

The vertical/linear generating unit J includes (FIGS. 8 & 9) a stator 140 and several armatures 142, the latter of which reciprocate in the former under power supplied by the drive unit H. To this end, the reciprocating motion produced by the drive unit H is transferred to the armatures 142 through cables 144 that extend over the convex surface 114 on the head 112 of the walking beam 106 and are secured to the head 112 at the upper end of the surface 114. The armatures 142 reciprocate along an axis Y.

The stator 140 includes a frame 150 having vertical tracks 152 along its sides. In addition, the stator 140 has coils 154 which extend transversely across the frame 150, and are thus oriented horizontally. The coils 154 are organized in sets 156, with each set 156 including an equal number of coils 154 on each side of a space 158 in which the armatures 142 are located. The sets 156 are arranged vertically with gaps 160 between successive sets 156. The distance between the upper and lower coils 154 in each set 156 corresponds generally to the length of the stroke for the head 112 on the walking beam 106 of the drive unit H.

The armatures 142 are arranged vertically on a carrier 168 within the space 158 between the coils 154 of the stator 140, there being a single armature 142 for each set 156 of coils 154. The carrier 170 includes a rod 170 that extends from its upper end to its lower end and in between passes through the armatures 142. At its upper end the rod 172 is connected to the cable 144 through a dielectric coupling 172. Thus the armatures 142 reciprocate in the space 158 as the walking beam 106 oscillates. The carrier 168 has guides 174 projecting laterally from it, and they follow the tracks 152 of the stator 140 such that the carrier 168 and the armatures 142 on it are confined in all directions horizontally, but are free to move vertically, both upwardly and downwardly. To this end, the guides 174 may include rollers 176 that follow the tracks 152. The armatures 142 contain permanent magnets and extend horizontally from one side of the carrier 168 to the other. Indeed, the magnets of the armatures 142 and the coils 154 of the stator 140 are essentially the same length. Moreover, the spacings between successive sets 168 of armatures 142 and the spacing between the gaps 160 that separate successive sets 156 of coils 154 on the stator 140 are about equal. Actually, each armature 142 preferably comprises a magnetic material encased in a jacket formed from steel plates. The rod 170 passes through the jackets of the armatures 142 and is welded to them. The magnetic material should be a substance, such as neodymium, that is characterized as a “super powerful permanent magnet”. Finally, the carrier 168 also includes a counterweight 178, preferably at its bottom, to overcome magnetic drag. The rod 170 attaches to the counterweight 178 as well.

Each armature 142 produces a magnetic flux. Being on the carrier 168, each armature 142 reciprocates in the space 158 between those coils 154 of the set 156 with which it is identified. The movement induces a current in the coils 154 of the set 156, and that current serves to power the electrical motor 120 of the drive unit H. The other armatures 142 likewise reciprocate between the coils 154 of their respective sets 156 and produce more electrical power. While some of the electrical power operates the motor 120 of the drive unit H, the remainder is available for introduction into a power grid. On the other hand, the motor 120 may be powered by some outside source of energy.

While the facility G is described in terms of a vertical/linear power generation, one of ordinary skill in the art using the present disclosure as a guide would recognize that rather than using vertical/linear power generation unit, a rotary power generation unit may be implemented. This facility can generate electricity by using multiple pump jacks to maintain a constant torque on the generator drive shaft that provides power to a conventional rotary generator. As a result, the present invention is intended to cover rotary power generation units and the present invention is intended to cover such rotary power generation units that would be used with a converted pump jack or similar machines. Lufkin, Dreher, Weatherford and other manufacturers make pump jacks or similar machines that are convertible for use in this facility for the generation of electricity.

One of ordinary skill in the art using the present disclosure as a guide would recognize that rather than using a walking beam or pump jack as a drive unit, the vertical/linear generator or conventional rotary generator could be articulated with a motor-driven eccentric device or by a motor-driven pulley type of mechanical device. As such, the present invention is intended to cover the generation of electricity produced by the described and referenced facilities and process.

1. An electrical generation facility comprising:
a drive unit including a beam that pivots about an axis that extends transverse to the beam; and
an electrical generating unit including a stator and an armature, the armature being coupled to and displaced relative to the stator by the beam of the drive unit.

2. A generation facility according to claim 1 wherein the beam has at one of its ends a head provided with a convex surface, and the beam is connected to the armature of the generating unit through a cable that passes over the convex surface of the head.

3. A generation facility according to claim 1 wherein the drive unit is a pump jack.

4. A generation facility according to claim 1 wherein the drive unit includes:
a frame;
a post extended upwardly from the frame and supporting the beam;
a motor on the frame;
a crank arm supported on the frame and coupled to the motor such that the motor rotates the crank arm,
and connecting rods coupling the crank arm to the beam such that rotation of the crank arm imparts a rocking motion to the beam.

5. A generation facility according to claim 4 wherein the beam at one of its ends has a head provided with a convex surface, and the armature is connected to the beam through a cable that passes over the convex surface.

6. A generation facility according to claim 1 wherein the stator of the generating unit includes at least one coil and the armature includes at least one magnet that moves along the coil.

7. A generation facility according to claim 6 wherein the generating unit also includes a carrier to which the magnet is attached and further comprising a track along which the carrier moves.

8. A generation facility according to claim 1 wherein the armature is polygonal shape to suit design of coils.

9. A generation facility according to claim 1 wherein the armature is polygonal in cross-section.

10. A generation facility according to claim 1 wherein the armature is triangular in cross section and has magnets arranged in three set to accommodate 3 phase current there being a separate set along each side of the armature; and wherein the stator has coils arranged in three sets, there being a separate set along each magnet set for the armature.

11. A generation facility according to claim 1 wherein the armature is a steel encased magnet fitted with extension steel rods connected on both ends to rollers in a track that allows the articulation of the armature(s).

12. A process for generating electricity, said process comprising;
imparting an oscillating motion to a beam; and
with the beam imparting relative movement between an armature and coils, so that a current flows through the coils.

13. The process according its claim 12 wherein the beam is a walking beam of a pump jack.

14. The process according to claim 12 wherein the armature is one of several armatures and the coils are arranged in multiple sets, there being a separate armature for each set of coils.

15. A vertical/linear generating unit comprising:
coils arranged in sets along an axis, and an armature for each set of coils, the armatures being mounted relative to the coils such reciprocating between the armatures and coils can occur along the axis X.

16. A vertical/linear generating unit according to claim 15 wherein the coils of each set are on both sides of the armature of the set.

17. A vertical/linear generating unit according to claim 16 wherein the armature moves vertically and the coils remain fixed in position.

18. A vertical/linear generating unit according to claim 17 wherein the length of reciprocation for the armature is about the same as the distance any set of coils occupies along the axis.

19. A vertical/linear generating unit according to claim 16 wherein the armature can remain fixed in position and the coils move vertically.
